(19) United States
(12) Patent Application Publication
(10) Pub. No.: US 2012/0008806 A1
(43) Pub. Date: Jan. 12, 2012

(54) VEHICLE AUDIO SYSTEM WITH HEADREST INCORPORATED LOUDSPEAKERS

(75) Inventor: Wolfgang Hess, Karlsbad (DE)

(73) Assignee: Harman Becker Automotive Systems GmbH, Karlsbad (DE)

(21) Appl. No.: 13/177,850

(22) Filed: Jul. 7, 2011

(30) Foreign Application Priority Data
Jul. 8, 2010 (EP) EP 10 168 911.5

(51) Int. Cl. H04R 5/02

(52) U.S. Cl. 381/302

(57) ABSTRACT

A vehicle audio system includes at least two loudspeakers incorporated into a headrest of a vehicle. Protective caps are provided for the loudspeakers at the headrest above each of the two loudspeakers and extend at least partially in a direction in which sound is emitted from the loudspeakers. An audio signal processor receives an audio input signal and is configured for generating audio output signals for the two loudspeakers such that the audio output signals are perceived by a user sitting on a seat on which the headrest is provided as a virtual soundfield. A database includes cap compensating information that compensates for an influence by the protective caps on the audio output signals emitted by the two loudspeakers. The audio signal processor is further configured for generating the virtual soundfield for said user taking into account the cap compensating information.

### RELATED APPLICATIONS

This application claims priority to European Patent Application Serial No. 10 168 911.5, filed on Jul. 8, 2010, titled VEHICLE AUDIO SYSTEM WITH HEADREST INCORPORATED LOUDSPEAKERS, which application is incorporated in its entirety by reference in this application.

### BACKGROUND OF THE INVENTION

1. Field of the Invention

The present invention relates to vehicle audio systems in which loudspeakers are incorporated into a headrest of a vehicle seat and to methods for generating a virtual soundfield for a user sitting on a vehicle seat.

2. Related Art

In convertible cars, loudspeakers for producing sound signals may be exposed to different weather conditions. The loudspeakers need to be protected against rain and direct sun. Furthermore, in convertible vehicles the noise level within the vehicles during driving may be quite strong. As a result, drivers of convertible vehicles may use a much higher audio signal level as compared to drivers of non-convertible vehicles. The strong audio signals emitted by loudspeakers in a convertible car may be annoying to other people in the surrounding area; i.e., outside of the vehicle. Furthermore, strong currents are needed to output the high audio signals resulting in high demands on the vehicle battery.

In view of the foregoing, an ongoing need exists for providing a vehicle audio system in which the sound output by the vehicle audio system may only be slightly (or not at all) perceived by people outside of the vehicle. In addition, a need exists for providing a vehicle audio system requiring less battery power. Furthermore, a need exists for loudspeakers in vehicle audio systems that are protected against the weather, which may be especially important for convertible vehicles.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a vehicle audio system is provided. The vehicle audio system includes at least two loudspeakers, a protective cap for each of the loudspeakers, an audio signal processor and a database. The loudspeakers are incorporated into a headrest of a vehicle. The protective cap is provided at the headrest above each of the loudspeakers. The protective cap extends at least partially in a direction in which the sound from each of the loudspeakers is emitted. The audio signal processor is configured for receiving an audio input signal and generating audio output signals for the loudspeakers. The audio output signals are output by the loudspeakers and perceived by a user sitting on a seat in which the headrest is provided as a virtual soundfield. The database includes cap compensating information configured for compensating for an influence by each protective cap on the audio output signals emitted by the loudspeakers. The audio signal processor is further configured for generating the virtual soundfield taking into account the cap compensating information.

According to another implementation a method for generating a virtual soundfield for a user sitting on a vehicle seat is provided. An audio input signal is received in an audio signal processor. A database in communication with the audio signal processor is provided. The audio input signal is processed in the audio signal processor to generate audio output signals. The audio output signals are output via at least two loudspeakers to create the virtual soundfield for the user. The loudspeakers are incorporated into a headrest of the vehicle seat. Each loudspeaker is protected by a protective cap provided at the headrest above each loudspeaker and extending at least partially in a direction in which the sound from each loudspeaker is emitted. The database includes cap compensating information to compensate for an influence by each protective cap on the audio output signals to be emitted by the loudspeakers. Processing the audio input signal includes taking into account the cap compensating information.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic illustration of an example of headrest incorporated loudspeakers according to one implementation of the present invention.

FIG. 2 is a schematic illustration of an example of an audio system according to one implementation of the present invention.

FIG. 3 is a detailed schematic illustration of an audio signal processor of the audio system shown in FIG. 2.

FIG. 4 is a schematic illustration showing the generation of a virtual soundfield according to one implementation of the present invention.

FIG. 5 is a schematic showing the generation of a user specific virtual soundfield for two different users with cross soundfield cancellation according to one implementation of the present invention.

FIG. 6 is a schematic flowchart showing an example of a method for generating a virtual soundfield for one user according to one implementation of the present invention.

### DETAILED DESCRIPTION

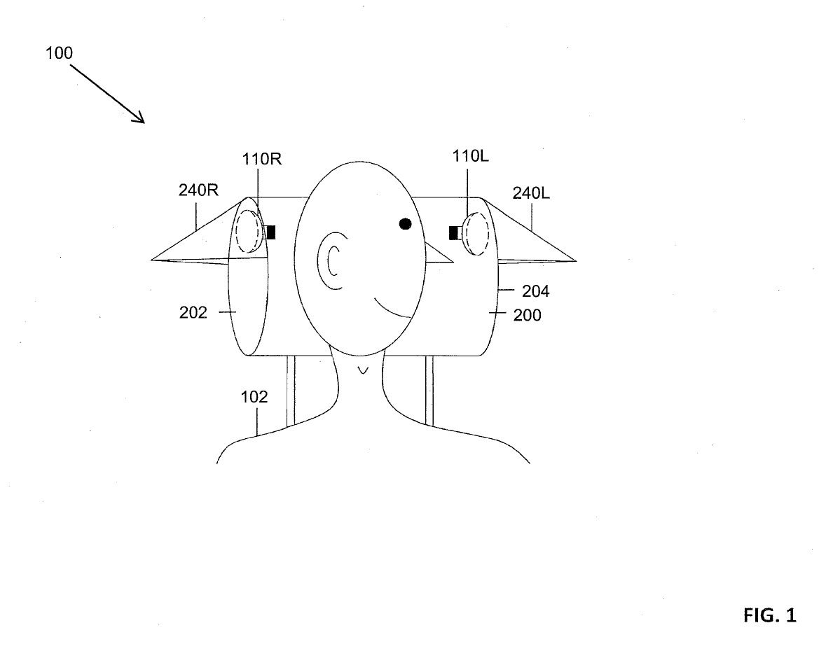

FIG. 1 is a schematic illustration of an example of headrest incorporated loudspeakers 110R, 110L according to one implementation of the present invention. A user 102 is shown with his/her head against a headrest 200 of a vehicle seat. The headrest 200 may include two side surfaces 202, 204 in which the loudspeakers 110R, 110L are incorporated, respectively. The two loudspeakers 110R, 110L may emit a sound signal for the user 102. The vehicle seat and the headrest 200 may be located in a convertible car, for example. For protecting the loudspeakers 110R, 110L against the environment (e.g., the sun or rain), protective caps 240R, 240L may be installed above the loudspeakers 110R, 110L, respectively. The protective caps 240R, 240L may also protect against particles in the airstream in a vehicle while driving (e.g., flies, mosquitoes, dirt, etc.). In general, the protective caps 240R, 240L may extend (at least partially) in the direction (e.g., parallel to the direction) in which the sound from the loudspeakers 110R, 110L is emitted. As shown in FIG. 1, the inner surfaces of the protective caps 240R, 240L may be concave-shaped, which may direct the sound emitted from the loudspeakers 110R, 110L towards a lower part of the vehicle cabin and/or to the ears of the user 102. In this way, the protective caps 240R, 240L act as reflectors or guides for the emitted sound signal from the loudspeakers 110R, 110L. The protective caps 240R, 240L may be configured to meet safety requirements concerning other passengers in the vehicle, in case of an accident. The airstream in the vehicle while the vehicle is being driven may influence the design of the protective caps 240R, 240L. In some implementations, the outer surfaces of the protective caps 240R, 240L may be covered with the same material as the headrest 200 for aesthetic purposes. As shown in FIG. 1, the two loudspeakers 110R, 110L may be located in close proximity to the ears of the user 102, and the audio output signal volume may be lowered as compared to situations in which the loudspeakers 110R, 110L are located elsewhere in the vehicle at a greater distance from the ears of the user 102. The position of the loudspeakers 110R, 110L and the shape and position of the protective caps 240R, 240L help keep the sound of the audio output signal contained within the vehicle such that people outside the vehicle are less disturbed by the audio output signal. The two loudspeakers 110R, 110L shown in FIG. 1 are not necessarily the only loudspeakers provided in the vehicle. For example, every headrest in the vehicle may include a pair of loudspeakers incorporated therein. Since the area of the headrest 200 for accommodating the loudspeakers 110R, 110L is limited, the loudspeakers 110R, 110L may be relatively small; e.g., the loudspeakers 110R, 110L may be satellite components of a vehicle loudspeaker system. The loudspeakers 110R, 110L may be configured for a frequency range above approximately 100 Hz (e.g., ranging from about 100 Hz to about 15,000 Hz, or from about 100 Hz to about 18,000 Hz). In view of the small distance between the loudspeakers 110R, 110L and the ears of the user 102, a low signal level of the audio output signal from the loudspeakers 110R, 110L may be sufficient for the user 102, even when the vehicle in which the loudspeakers 110R, 110L are incorporated is a convertible and is being driven. An additional loudspeaker configured for lower frequencies (e.g., a woofer) may be provided elsewhere in the vehicle cabin.

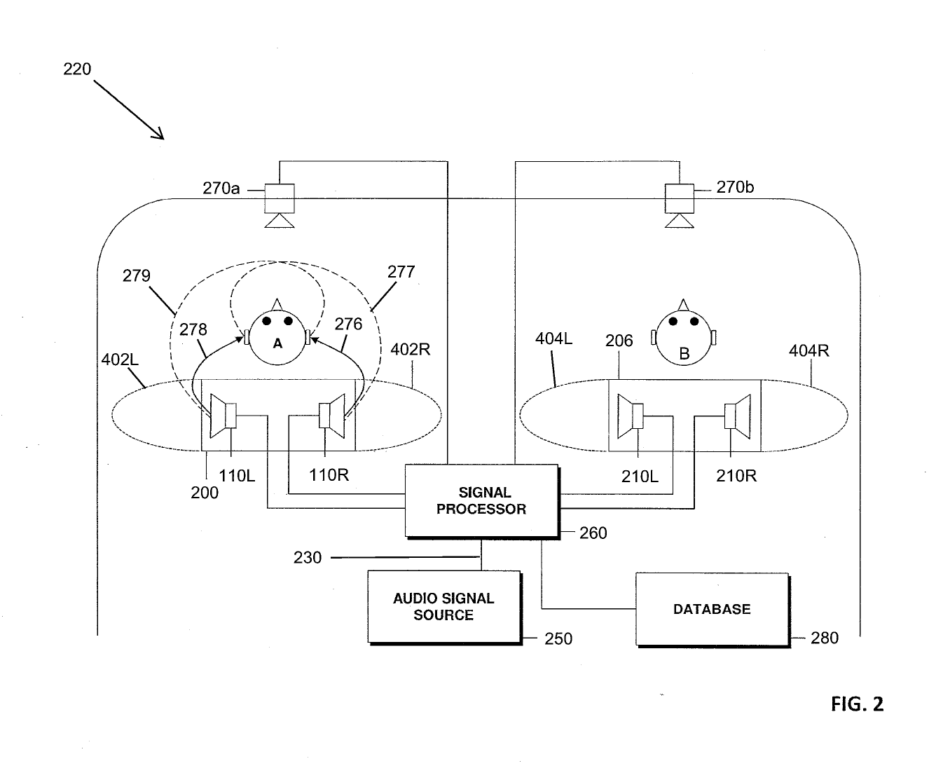

As discussed below in conjunction with FIG. 2 through FIG. 6, a virtual soundfield may be generated by the audio output signals from the two loudspeakers 110R, 110L. FIG. 2 is a schematic illustration of an example of an audio system 220 according to one implementation of the present invention. In some implementations, the audio system 220 may be used in conjunction with convertible vehicles. In some implementations, the audio system 220 may be used in conjunction with closed vehicles, such as trucks, or in motor boats or airplanes.

In FIG. 2, user A is sitting in a first seat (not shown) including a first headrest 200 in which two loudspeakers 110L, 110R are incorporated. Protective caps 240R, 240L are installed above the loudspeakers 110R, 110L, respectively, and are shown in FIG. 2 as phantom lines for the sake of clarity. User B is sitting on an adjacent second seat (not shown) including a second headrest 206 in which two loudspeakers 210R, 210L are incorporated. Protective caps 404R, 404L are installed above the loudspeakers 210R, 210L, respectively. The audio system 220 may include an audio signal source 250, which provides the audio input signal 230 to be output (e.g., after processing) by one or more of the loudspeakers 110R, 110L, 210R and 210L. The audio signal source 250 may be, for example, a CD, a DVD or a hard disk on which audio signals may be stored in digital form. The audio system 220 may include an audio signal processor 260 that is configured for processing the audio input signal 230 received from the audio signal source 250 before it is output to one or more of the loudspeakers 110R, 110L, 210R and 210L. The signal processor 260 may process the audio input signal 230 received from the audio signal source 250 in such a way that the audio output signals output by the loudspeakers 110R, 110L, 210R and 210L are perceived by the users A and B as a virtual soundfield. In the virtual soundfield, the users A and B may be provided with a spatial auditory representation of the audio output signals (e.g., the audio output signals 276, 278) that are output by the loudspeakers 110R, 110L, 210R and 210L. The virtual soundfield may be a virtual surround sound giving the users A and B the impression that many loudspeakers are provided and that the audio output signals output by the loudspeakers 1108, 110L, 210R and 210L come from different loudspeakers distributed in spaces where no loudspeakers are actually present. For example, a virtual surround sound may be created when the audio input signal 230 from the audio signal source 250 is processed by the signal processor 260 in such a way that the audio output signal 278 emitted by loudspeaker 110L is transmitted to the left ear of user A, whereas the audio signal component 279 output by loudspeaker 110L for the right ear of user A is suppressed. Similarly, the audio output signal 276 output by loudspeaker 11OR is transmitted to the right ear of user A, and the audio signal component 277 output by loudspeaker 11OR for the left ear of user A is suppressed. In the example illustrated in FIG. 2, it, is assumed that both users A and B are hearing audio signals from the same audio signal source 250. As with user A, a virtual soundfield may be provided for user B using the loudspeakers 210L and 210R. The virtual soundfields created for each user A, B may be referred to as virtual headphones, a concept that is discussed in further detail below.

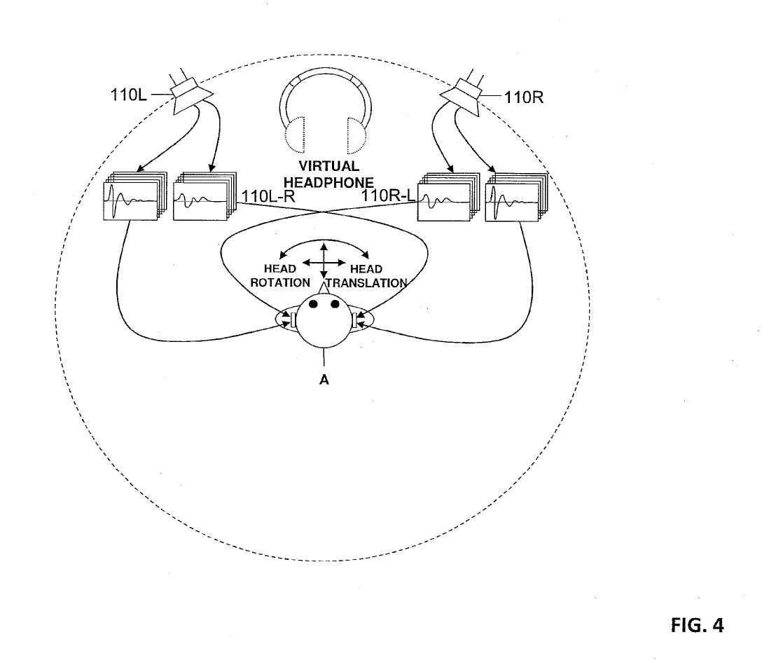

In FIG. 2, for illustrative purposes, the loudspeakers 110R, 110L, 210R and 210L are not shown in their actual positions, but are illustrated at a significant distance from the users A and B to more clearly show the propagation of the sound output signals 276, 278 from the loudspeakers 110R and 110L to the right and left ears of the user A. In the audio system 220, a spatial auditory representation of the audio input signal 230 may be obtained by emitting a binaural audio output signal 278 from loudspeaker 110L to the left ear of user A, and a binaural audio output signal 276 may be emitted by loudspeaker 110R and brought to the right ear of user A. To this end, a crosstalk cancellation may be utilized in which the audio signal component 279 emitted from loudspeaker 110L may be suppressed for the right ear of the user A (see also 110L-R in FIG. 4) and the audio signal component 277 of the loudspeaker 110R may be suppressed for the left ear of the user A (see also 110R-L in FIG. 4). A binaural sound signal is normally intended for replay using headphones. When a normal stereo signal is played back with headphones, the listener perceives the signal in the middle of the head. When a binaural recorded sound signal is played back with headphones, the position from which the signal was originally recorded is simulated. In FIG. 2, the audio output signals 276, 278 are not output by headphones, but via loudspeakers 110L, 110R, 210L, 210R provided in the headrests 200, 206. As illustrated in FIG. 4, the transmission paths from the loudspeakers 110R, 110L to the ears of the user A (i.e., the virtual soundfield as perceived by the user A) depends on the head position (i.e., the position of the ears) of the user A. The human auditory system localizes a sound source and the localization may depend on the manner in which a sound signal travels to an ear of a user from a loudspeaker. In some implementations, a fixed head position may be taken as a basis for the spatial auditory representation calculation (where the calculation may be carried out by the signal processor 260). The position of the head of a driver of a vehicle may be relatively fixed. Generally, the height of a user should not affect the virtual soundfield, as the relative position between the headrest and the head is the same for people of different heights, assuming the headrest is properly adjusted.

Continuing with FIG. 2, in some implementations a camera (or other suitable image sensor) may be provided for each user, such as the cameras 270a, 270b for users A, B, respectively. The cameras 270a, 270b may be used to determine the respective head positions of the users A, B by, for example, using pattern recognition techniques in which a face or any other predetermined part of the head is recognized in images taken by the cameras 270a, 270b. From the movement of the recognized part of the image, the head movement may be deduced. The camera 270a or 270b may determine a 3-dimensional translation of the head of the user A or B in addition to three different possible rotations. The signal processor 260 may be connected to a database 280. The database 280 may include cap compensating information which may be utilized by the signal processor 260 to compensate for any influence of the protective caps 240L, 240R, 404L, 404R on the audio output signals (e.g., audio output signals 276, 278) emitted by the loudspeakers 110L, 110R, 210L, 210R and perceived by the users A, B as a virtual soundfield. The database 280 may include binaural room impulse responses (BRIRs) for different head translation and rotation positions. If the head position is not tracked, a fixed general head position is used and the BRIR for this fixed head position may be provided in the database 280. The BRIRs may take into account the transition path from each loudspeaker 110R, 110L, 210R, 210L to the respective eardrum of the users A, B, and possible reflections of the audio output signals in the vehicle cabin. For example, a user specific binaural sound signal for user A may be determined by the signal processor 260, using the tracked head position of the user A and the relevant BRIR stored in the database 280. The user specific binaural sound signal may be obtained by determining a convolution of the audio input signal 230 with the BRIR. In some implementations, a crosstalk cancellation may then be performed, in which the signal path from the loudspeaker 110L or 210L to the right ear of the user A or B and from the loudspeaker 11OR or 210R to the left ear of the user A or B may be suppressed. The crosstalk cancellation may be obtained by calculating a new filter, which may depend on the tracked head position; i.e., the crosstalk cancellation may be obtained by determining a convolution of the user specific binaural sound signal with the newly determined crosstalk cancellation filter. After processing with this new filter, a crosstalk cancelled user specific sound signal may be obtained for each of the loudspeakers 110R, 110L, 210R and 210L, which, when output to the users A, B, provides a spatial perception of the respective audio output signal to the users A, B in which the users A, B have the impression that the audio output signals are output not only from the direction determined by the position of the loudspeakers 110R, 110L, 210R and 210L, but from multiple other points in space. A more detailed analysis of crosstalk cancellation, and how it is dependent on the head rotation of a user is described in “Performance of Spatial Audio Using Dynamic Cross-Talk Cancellation” by T. Lentz, I. Assenmacher and J. Sokoll in Audio Engineering Society Convention Paper 6541 presented at the 119^{th} Convention, October 2005, 7-10, and in “Dynamic Crosstalk Cancellation for Binaural Synthesis in Virtual Reality Environments” by T Lentz in J. Audio Eng. Soc., Vol. 54, No. 4, April 2006, pages 283-294, which are incorporated in this application by reference in their entireties.

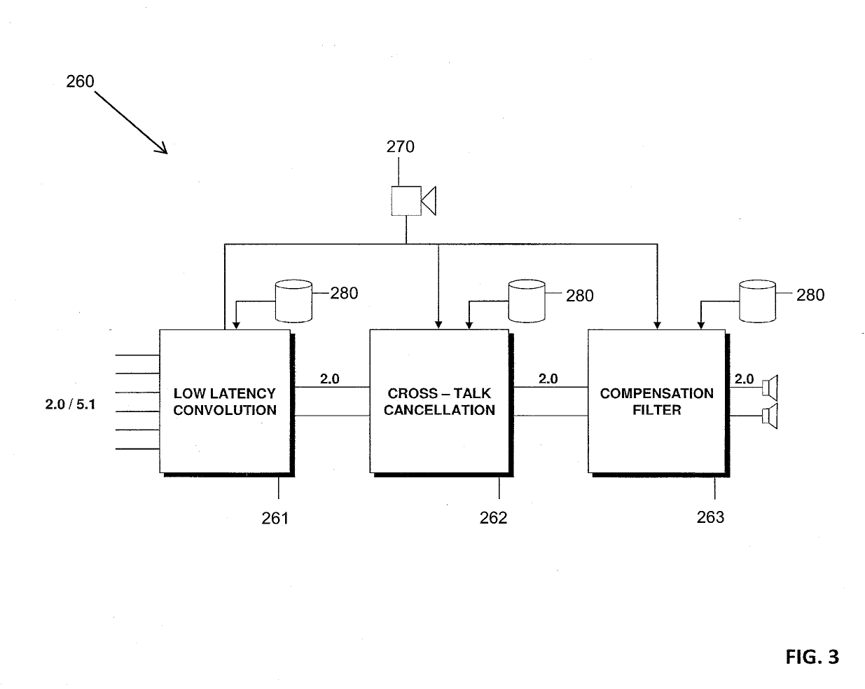

FIG. 3 is a detailed schematic illustration of the signal processing that may be carried out in the audio signal processor 260 shown in FIG. 2. The audio input signal 230 from the audio signal source 250, such as a CD, DVD, or radio, may be, for example, a 1.0. 2.0. 5.1 or 7.1 signal. The audio input signal 230 may be a multichannel audio signal of any suitable format. In FIG. 3, for illustrative purposes, the different processing steps are symbolized by interconnected modules 261, 262, 263. It will be understood that the various processing steps illustrated in FIG. 3 may be carried out by a single audio signal processing unit. In conjunction with FIG. 3, the various signal processing steps are discussed with head tracking (i.e., via camera 270), where the movement of the user's head is taken into account. However, it will be understood that in some implementations, the processing steps shown in FIG. 3 may be carried out based on a fixed position of the user's head. At a low latency convolution module 261 (“the first module”), information corresponding to the user's head position may be received from a camera 270 (or “image sensor”), and a BRIR associated with the head position may be extracted from the database 280. In the first module 261, the multichannel audio input signal 230 may be converted into a binaural audio output signal that, if output by a headphone, would give a three dimensional impression to the user. This user specific binaural sound output signal may be obtained by determining a convolution of the multichannel audio input signal 230 with the corresponding BRIR of the tracked head position. The user specific binaural sound output signal may then be further processed in a crosstalk cancellation module 262 (“the second module”), where a crosstalk cancellation filter may be calculated. A convolution of the user specific binaural sound output signal with the crosstalk cancellation filter may be determined. The output of the second module 262 may be referred to as a crosstalk cancelled user specific sound signal that, if output by a loudspeaker, would give a user the same impression as the user listening to the user specific binaural sound signal using the headphone discussed above in conjunction with the first module 261. As the crosstalk cancellation may depend on the position of the head, the corresponding head position information may be received by the second module 262 from the image sensor 270. In a compensation filter module 263 (“the third module”), the influence of the protective caps 240R, 240L, 404L, 404R may be determined The database 280 may include predetermined cap compensation filters for different head positions (which may have been determined in advance using a dummy head sitting in the corresponding vehicle, for example). The different cap compensation filters may be determined using measurements of the sound signals emitted by the loudspeakers 110R, 110L, 210R, 210L with the protective caps 240R, 240L, 404L, 404R being provided. These measurements allow for the determination of the influence of the protective caps 240R, 240L, 404L, 404R on the emitted sound signals from the loudspeakers 110R, 110L, 210R, 210L. In the third module 263, a convolution of the crosstalk cancelled user specific sound signal emitted from module 262 with the cap compensation filter of the corresponding head position is determined. The cap compensated audio output signal (i.e., the output from the third module 263) may be determined for each loudspeaker 110R, 110L, 210R and 210L and the respective cap compensated audio output signal may be fed to the appropriate loudspeaker 110R, 110L, 210R or 210L. The emitted sound signals by the loudspeakers 110R, 110L, 210R, 210L generate virtual soundfields for the users A and B. If the position of the head of the user A or B is not tracked, a filter for a mean head position of the user may be provided for the generation of the binaural sound signal, the crosstalk cancellation filter and the cap compensation filter, respectively. The signal processing as shown in FIG. 3 may be carried out for each user A and B shown in FIG. 2.

In FIG. 3, three convolutions are carried out in the signal path. The filtering for crosstalk cancellation and cap compensation may be carried out in succession, as discussed above. In some implementations, the three different convolutions may be combined into one convolution using a predetermined filter. Crosstalk cancellation using head tracking is described in more detail by T. Lentz in “Dynamic Crosstalk Cancellation for Binaural Synthesis in Virtual Reality Environments”, J. Audio Eng. Soc., Vol. 54, No. 4, April 2006, pages 283-294, which is incorporated by reference in this application in its entirety.

As stated above, the BRIRs for the different head positions may be determined in advance in the vehicle using a dummy head. The different BRIRs may be obtained by placing the dummy head in the vehicle with the different possible head positions, with microphones being provided in each ear of the dummy. The head related transfer functions and the influence of the vehicle cabin on the signal path from the loudspeaker 110R, 110L, 210R or 210L may be determined. If reflections are disregarded, the head related transfer functions may be used in lieu of the BRIRs. For example, the head position may be tracked by the image sensor 270 by determining translations in three different directions. Rotations of the head may also be tracked. Thus, the set of predetermined BRIRs may contain BRIRs for the different possible translations and rotations of the head of a user. In the vehicle environment, it may be sufficient to consider fewer degrees of freedom for translations (e.g., left or right and backward or forward), and only one rotation (e.g., left or right). As discussed above, the user specific binaural sound signal at a defined common head position without head tracking may be be calculated by determining a convolution of the audio input signal with the BRIR for the defined head position.

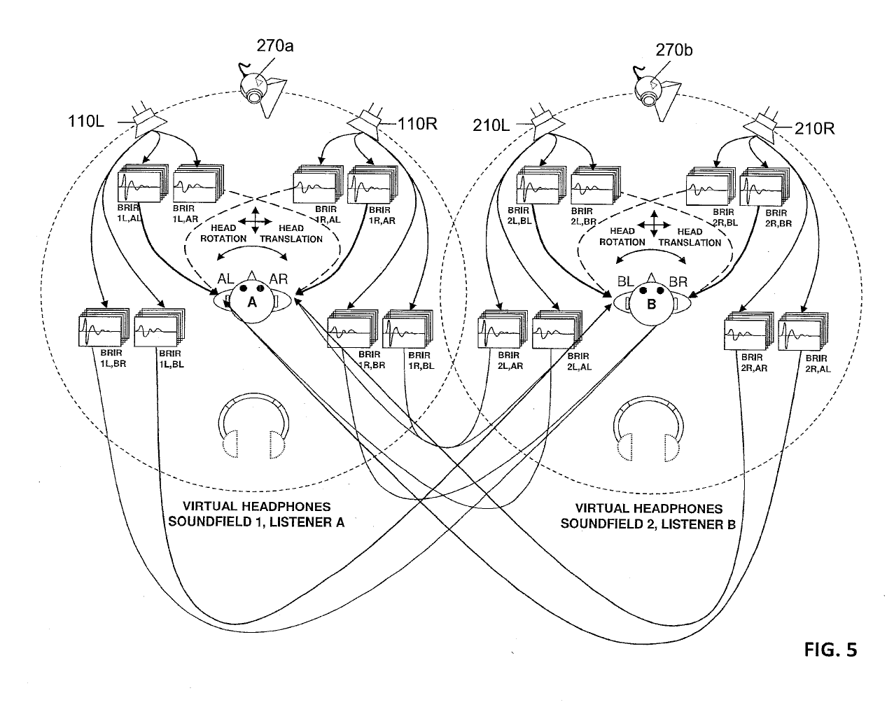

FIG. 5 is a schematic showing the generation of user specific virtual soundfields for two different users A and B with cross soundfield cancellation according to one implementation of the present invention. As the signal level of each soundfield emitted by the two pairs of loudspeakers 110R, 110L and 210R, 210L is low, the disturbance (from the soundfield of user B) of the soundfield produced for user A may be low, and vice versa. However, in some implementations, a cross soundfield cancellation may be carried out in which the soundfield generated for user A is suppressed for user B, and vice versa. In FIG. 5, the two loudspeakers 110L, 110R for the first user A generate a user specific sound signal for the first user A, and the two loudspeakers 210L, 210R generate a user specific sound signal for the second user B. The two cameras 270a, 270b are provided to determine the head position of the two users A, B, respectively. The first loudspeaker 110L outputs an audio signal which would, under normal circumstances, be heard by the left and right ears of user A, designated as AL and AR, respectively. The signal 110L, AL corresponding to the signal emitted from loudspeaker 110L for the left ear AL of user A is not suppressed. The signal 110L, AR shown in a dashed line for the right ear AR of user A may be suppressed. Similarly, the signal 110R, AR should arrive at the right ear AR of user A, whereas the signal 110R, AL for the left ear AL of the user A may be suppressed. To avoid the situation in which the audio signals from the loudspeakers 110L and 110R are perceived by user B, a cross soundfield cancellation may be carried out in which the soundfield intended for user A is suppressed for user B. The signals to be suppressed from loudspeaker 110L are shown as 110L, BR and 110L, BL. Similarly, the signals emitted by loudspeaker 110R should be suppressed for both ears BL and BR of user B. In a similar manner, the sound signals emitted from loudspeakers 210L and 210R may be suppressed for user A. Thus, the cross soundfield cancellation works in a manner that is similar to the crosstalk cancellation.

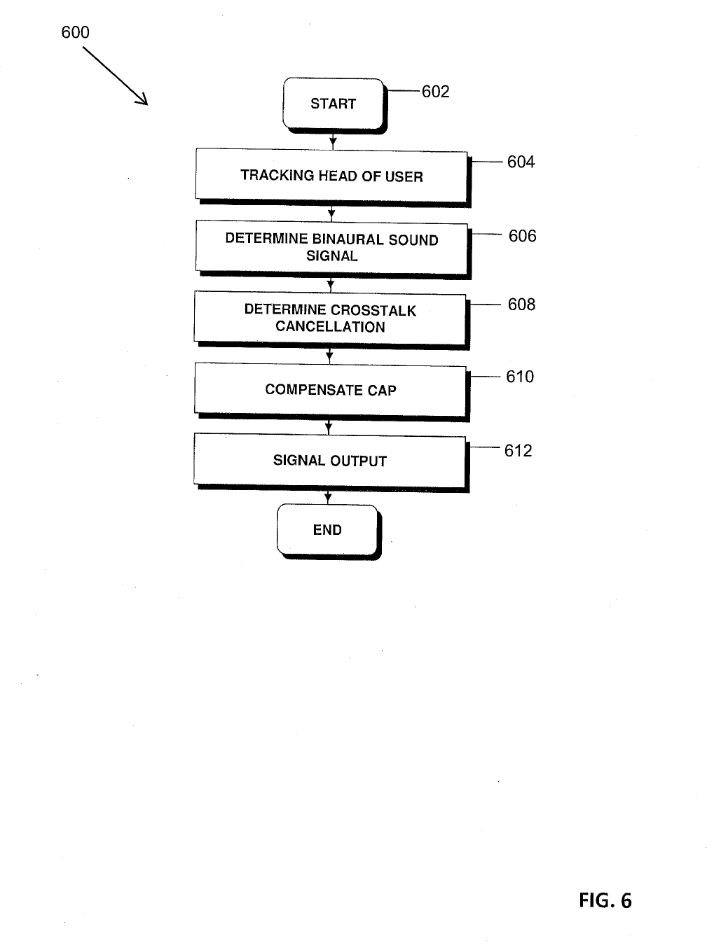

FIG. 6 is a schematic flowchart showing an example of a method 600 for generating a virtual soundfield for a user A or B according to one implementation of the present invention. In FIG. 6, the different steps for determining a user specific virtual soundfield without cross soundfield cancellation are summarized. The method 600 starts at step 602. At step 604, the head of the user A or B is tracked. In tracking the user's head position, the binaural sound signal may be determined in step 606 by calculating a convolution of the audio input signal 230 with a BRIR for the determined head position. At step 608, crosstalk cancellation is carried out as described above in conjunction with FIG. 3. At step 610, the influence of the protective cap 240L, 240R, 404L or 404R on the emitted sound signal from the respective loudspeaker 110L, 110R, 210L or 210R is taken into account (i.e., via the cap compensation filter 263). At step 612, the audio output signal is output to the appropriate loudspeaker 110L, 110R, 210L and/or 210R (which corresponds to the audio output signal output from the third module 263 in FIG. 3). In implementations in which cross soundfield cancellation is carried out, the cross soundfield cancellation may be carried out after step 610. When the audio output signal is then output in step 612, a user specific virtual soundfield is obtained for the user A or B.

The loudspeakers 110L, 110R, 210L, 210R provided in the headrests 200, 206 need not be located with the outer surfaces of the loudspeakers 110L, 110R, 210L, 210R being parallel to the side surfaces of the headrests 200, 206. The loudspeakers 110L, 110R, 210L, 210R may be slightly angled relative to the outer surfaces of the headrests 200, 206. Furthermore, the form of the protective caps 240L, 240R, 404L, 404R may be influenced by the need for protecting the loudspeakers 110L, 110R, 210L, 210R, the need to avoid noise generated by the airstream travelling around the protective caps 240L, 240R, 404L, 404R, and/or the need to obtain an acceptable design for the user.

It will be understood, and is appreciated by persons skilled in the art, that one or more processes, sub-processes, or process steps described in connection with FIGS. 1-6 may be performed by hardware and/or software. If the process is performed by software, the software may reside in software memory (not shown) in a suitable electronic processing component or system such as one or more of the functional components or modules schematically depicted in FIGS. 1-6. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A vehicle audio system comprising:
at least two loudspeakers incorporated into a headrest of a vehicle;
a protective cap for each of the loudspeakers provided at the headrest above each of the loudspeakers and extending at least partially in a direction in which the sound from each of the loudspeakers is emitted;
an audio signal processor configured for receiving an audio input signal and generating audio output signals for the loudspeakers, where the audio output signals are output by the loudspeakers and perceived by a user sitting on a seat in which the headrest is provided as a virtual soundfield; and
a database including cap compensating information configured for compensating for an influence by each protective cap on the audio output signals emitted by the loudspeakers, where the audio signal processor is configured for generating the virtual soundfield taking into account the cap compensating information.

2. The vehicle audio system of claim 1, further comprising an image sensor in communication with the audio signal processor, the image sensor being configured for tracking the position of the head of the user, where the database includes head position related data, and where the audio signal processor is configured for generating the virtual soundfield taking into account the tracked head position and the head position related data.

3. The vehicle audio system of claim 2, where the head position related data includes a set of binaural room impulse responses for different head positions of the user.

4. The vehicle audio system of claim 1, where each protective cap is configured for directing the audio output signals emitted by the loudspeakers to a region of a cabin of the vehicle located below the headrest.

5. The vehicle audio system of claim 1, where the loudspeakers are provided in side surfaces of the headrest.

6. The vehicle audio system of claim 1, where the audio output signals are user specific binaural sound signals determined by the audio signal processor.

7. The vehicle audio system of claim 6, where the audio signal processor is configured for performing a cross talk cancellation for the user specific binaural sound signals output by the loudspeakers.

8. The vehicle audio system of claim 1, where the audio signal processor is configured for performing a cross soundfield suppression in which the virtual soundfield generated for the user is suppressed for each ear of a second user in the vehicle.

9. The vehicle audio system of claim 1, where the loudspeakers are configured for outputting audio signals with a frequency of about 100 Hz or greater.

10. A method for generating a virtual soundfield for a user sitting on a vehicle seat, the virtual soundfield being generated by at least two loudspeakers incorporated into a headrest of the vehicle seat, each loudspeaker being protected by a protective cap provided at the headrest above each loudspeaker and extending at least partially in a direction in which the sound from each loudspeaker is emitted, the method comprising the steps of:
receiving an audio input signal in an audio signal processor;
providing a database in communication with the audio signal processor, where the database includes cap compensating information to compensate for an influence by each protective cap on audio output signals to be emitted by the loudspeakers;
processing the audio input signal in the audio signal processor to generate the audio output signals, where processing the audio input signal includes taking into account the cap compensating information; and
outputting the audio output signals via the loudspeakers to create the virtual soundfield for the user.

11. The method of claim 10, where processing the audio input signal includes generating a user specific binaural sound signal for the user.

12. The method of claim 10, where processing the audio input signal includes:
generating a cross talk cancelled user specific sound signal for the user by performing a cross talk cancellation such that if the cross talk cancelled user specific sound signal is output by a first loudspeaker for a first ear of the user, then the cross talk cancelled user specific sound signal is suppressed for a second ear of the user, and if the cross talk cancelled user specific sound signal is output by a second loudspeaker for the second ear of the user, then the cross talk cancelled user specific sound signal is suppressed for the first ear of the user.

13. The method of claim 10, where the audio output signals are generated using a fixed position of the user's head at the headrest.

14. The method of claim 10, further comprising tracking a position of the head of the user, where the database includes head position related data, and where the audio output signals are generated taking into account the tracked head position and the head position related data.

15. The method of claim 14, where the head position related data includes binaural room impulse responses.

16. The method of claim 10, where two vehicle seats are provided and the headrest of each vehicle seat includes at least two loudspeakers, and the processing of the audio input signal includes performing a cross soundfield suppression in which the audio output signals output by the loudspeakers in the headrest of one vehicle seat are suppressed for each ear of the user sitting on the other vehicle seat.
